(19) United States
(12) Patent Application Publication
(10) Pub. No.: US 2009/0104426 A1
(43) Pub. Date: Apr. 23, 2009

(54) Fibers, Tapes and Films Prepared from Olefinic and Segmented Elastomers

(75) Inventors: Bryan B. Sauer, Boothwyn, PA (US); Young H. Kim, Hockessin, DE (US); George Vassilatos, Wilmington, DE (US); Gary A. Johansson, Hockessin, DE (US); Raisa Kravchenko, Dee Why (AU)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E.I. DU PONT DE NEMOURS AND COMPANY

(21) Appl. No.: 12/341,403

(22) Filed: Dec. 22, 2008

Related U.S. Application Data
(63) Continuation of application No. 10/625,060, filed on Jul. 22, 2003.

(51) Int. Cl. C08F 10/06; B32B 5/02

(52) U.S. Cl. 428/221; 525/55; 524/502

(57) ABSTRACT

The present invention relates to stretchable, synthetic, polymeric fibers, tapes and films made from at least two types of thermoplastic elastomeric polymers. More specifically, this invention relates to stretchable synthetic, polymeric fibers, tapes comprising a segmented thermoplastic elastomeric polymer, and an olefinic, thermoplastic elastomeric polymer. This invention also relates to articles formed from such fibers, including yarns, garments, and other textile or related structures comprising such a composite filament or a film.

This application is a continuation of, and claims the benefit of, U.S. Ser. No. 10/625,060, filed Jul. 22, 2003, which is by this reference incorporated in its entirety as a part hereof for all purposes.

### FIELD OF THE INVENTION

The present invention relates to stretchable synthetic, polymeric fibers, tapes and films made from at least two types of thermoplastic, elastomeric polymers. More specifically, this invention relates to stretchable synthetic, polymeric fibers, tapes and films made from a segmented thermoplastic, elastomeric polymer and an olefinic thermoplastic, elastomeric polymer. This invention also relates to articles formed from such fibers, including yarns, garments, and other textile or related structures.

### BACKGROUND OF THE INVENTION

It is desired to impart stretchability into many products formed from synthetic fibers, including various garments such as sportswear and hosiery. It is also desired to improve the washfastness of the stretchable fabrics. It is generally well-known that washfastness is a problem with stretch fabrics having spun polyurethane or poly(ether ester) stretch fibers since these components can absorb a high concentration of the disperse dyes. The absorbed dye in the elastic yarns can diffuse out during laundering of garments prepared from the fibers.

Thermoplastic elastomeric copolyester ethers or copolyester esters have been used to make elastic fibers. A limitation of these fibers is the low elastic recovery, which results in a high permanent elongation and set. WO 97/45575 discloses an elastic fiber containing a mixture of a copolyester ether or a copolyester ester and a mixture of cross-linked rubbers. Fibers prepared from such a mixture demonstrate a lower set and a higher elongation to break compared to the pure thermoplastic copolyether ester or copolyester ether. Owing to the high viscosity, however, much difficulty is encountered in melt-spinning fibers that incorporate cross-linked rubber. For example, the usual values for the viscosity of a thermoplastic spinning material are in the range of 80 to 300 Pa-s. With the added presence of a cross-linked modifier, however, the viscosity increases to about 10⁶ Pa-s at a shear rate of 0.1/s and 1000 Pa-s at a shear rate of 200/s. Such high viscosity can be detrimental to the general process efficiency and ease. The present invention discloses stretchable fibers based on melt-spinnable thermoplastic elastomers that address the above issues of washfastness and processability.

What has now been found is an elastic fiber, tape and film containing a mixture of an ester-based or an amide-based segmented thermoplastic elastomer and a thermoplastic elastomeric polyolefin. The elastomeric polyolefin is an un-crosslinked thermoplastic material that can be easily melt-extruded, in contrast to the chemically crosslinked polyolefinic rubber described in WO 97/45575.

### SUMMARY OF THE INVENTION

One embodiment of this invention involves a fiber, tape or film containing (a) a segmented thermoplastic, elastomeric polymer, and (b) an un-crosslinked olefinic thermoplastic, elastomeric polymer, wherein the olefinic thermoplastic, elastomeric polymer is dispersed in a matrix of the segmented thermoplastic, elastomeric polymer.

Another embodiment of this invention involves a fiber having an axial core of a segmented thermoplastic, elastomeric polymer, and a sheath encasing the axial core that is an un-crosslinked olefinic thermoplastic, elastomeric polymer.

Another embodiment of this invention involves a fiber having an axial core of an un-crosslinked olefinic thermoplastic, elastomeric polymer, and a sheath encasing the axial core that is a segmented thermoplastic, elastomeric polymer.

Other embodiments of this invention involve a method for making a fiber, and articles prepared from a fiber.

In general, this invention concerns a fiber, tape or film formed from two or more components. One component is a low modulus thermoplastic polyolefin elastomer. The other component is a segmented polymer including poly(ether ester), poly(ester ester), poly(ether amide), or poly(ester amide), and the like. The composition from which such fiber, tape or film may be prepared may contain about 0.5 to about 80 wt % polyolefin elastomer, and about 20 to about 99.5 wt % segmented polymer. The invention provides processing improvements, lower cost, modified hydrophobicity, and modified water and dye absorption in the fiber.

### DETAILED DESCRIPTION OF THE INVENTION

An elastomeric polymer is a polymer that in mono-component fiber form, free of diluents, has a break elongation in excess of 100%, and that when stretched to twice its length, held for one minute, and then released, retracts to less than 1.5 times its original length within one minute of being released.

A thermoplastic polymer is a polymer that will soften and ultimately flow with the application of heat, but will return to its previous condition upon cooling, and that can be subjected to this cycle repeatedly. In a polymer that is crosslinked, by contrast, the molecular chains are joined to each other by primary chemical bonds. The polymer will become irreversibly solidified or set when heated, and cannot thereafter be melted. The olefinic thermoplastic polymers used in this invention are un-crosslinked (i.e. not crosslinked).

Thermoplastic elastomers suitable for use in the fibers of this invention include those made up of two types of units: (1) a generally amorphous segment that is soft in nature (e.g., a polydiol such as Terethane® polymer), and (2) a generally crystalline and/or hard segment that serves as an anchor for the soft segment. A thermoplastic elastomer comprising soft segments and hard segments may also be referred to as a segmented thermoplastic elastomer, and is sometimes also referred to as a block copolymer. Generally, the soft-segment molecular weight is predetermined by the fact that its length is defined as the soft blocks are extended by chain extenders, and then separated by hard blocks in the same chain.

Useful thermoplastic polyester elastomers include poly(ether esters) and poly(ester esters), which are segmented block copolymers built up from (i) hard, crystalline and relatively high-melting polyester segments, and (ii) soft, flexible and relatively low-melting polyether or polyester segments.

Suitable hard polyester segments for use in compositions according to this invention are, for instance, polyalkylene terephthalates, poly(butylene-naphthalene dicarboxylic acid), poly(cyclohexanedicarboxylic acid-cyclohexanemethanol) and preferably polybutyleneterephthalate and polytrimethyleneterephthalate. These and other types of hard polyester segments can be used to form a block copolymer, and a plurality of types of hard segments can also be used simultaneously.

Polyester units suited for the hard crystalline segment are built up, for instance, from an acid and a glycol. Suitable acids are, for instance, terephthalic acid and 2,6-naphthalenedicarboxylic acid. In addition to those, a small amount of a dicarboxylic acid such as isophthalic acid, an aliphatic dicarboxylic acid such as adipic acid or cyclohexane-1,4-dicarboxylic acid, or a dimeric acid may be used. The chosen glycol component of the polyester unit may be a glycol having, for instance, two to twelve carbon atoms, such as ethylene glycol, propylene glycol, tetramethylene glycol, neopentyl glycol, hexane diol or decane diol.

Suitable soft polyester segments are, for instance, aliphatic polyesters, including polybutylene adipate and preferably polytetramethyladipate and polycaprolactone. Mixtures of more than one type of soft-segment forming polyester may be used as well. In a poly(ester ester), the weight-average molecular weight of the soft, low-melting polymer segment is in the range of from about 200 g/mol to about 10000 g/mol, and preferably in the range of from about 400 g/mol to about 6000 g/mol. A further preferred range is of from about 400 g/mol to about 3000 g/mol.

In a poly(ester ester) polymer, the content of hard segments, by weight, may be from about 10% to about 70%, and is preferably from about 15% to about 35%. The content of soft segments, by weight, may be from about 30% to about 90%, and is preferably from about 85% to about 65%.

Poly(etherester)s useful in this invention are made by the reaction of a polyether glycol with a low-molecular weight diol (having a molecular weight, for example, of less than about 250) and a dicarboxylic acid or diester thereof. Useful polyether glycols include poly(ethyleneether) glycol, poly(tetramethyleneether) glycol, poly(tetramethylene-co-2-methyltetramethyleneether) glycol [derived from the copolymerization of tetrahydrofuran and 3-methyltetrahydrofuran], and poly(ethylene-co-tetramethyleneether) glycol. Useful low-molecular weight diols include ethylene glycol, 1,3-trimethylene glycol, 1,4-butanediol, 2,2-dimethyl-1,3-propylene diol, and mixtures thereof, 1,3-trimethylene glycol and 1,4-butanediol are preferred. Useful dicarboxylic acids include terephthalic acid, optionally with minor amounts (for example, less than 20 mol %) of isophthalic acid, and diesters thereof.

Suitable polyether segments are, for instance, polyalkylene oxides, including polytetramethylene oxide, polypropylene oxide, polyethylene oxide and blends of these and other polyalkylene oxides made from similar polyglycols. Highly suited are poly(ether esters) in which the polyester segments are polyalkyleneterephthalates, preferably polybutyleneterephthalate, and the polyether segments are polyalkyleneoxides, preferably polytetramethyleneoxide. A preferred poly(ether ester) contains polybutyleneterephthalate hard segments and polytetramethyleneoxide soft segments. A further preferred poly(ether ester) is prepared from polybutyleneterephthalate hard segments and soft segments that include a copolymer based on the repeat units of tetrahydrofuran and 3-methyl-tetrahydrofuran.

In a poly(ether ester), the weight-average molecular weight of the low-melting polymer segment is in the range of from about 200 g/mol to about 10000 g/mol, and preferably in the range of from about 400 g/mol to about 6000 g/mol. A further preferred range is of from about 400 g/mol to about 3000 g/mol. The content of hard segments, by weight, in the poly(ether ester) polymer may be from about 10% to about 70%, and is preferably from about 15% to about 35%. The content of soft segments, by weight, may be from about 30% to about 90%, and is preferably from about 85% to about 65%.

Suitable poly(ether ester)s may be processed at a temperature below that at which appreciable thermal degradation of the polymer would occur. This imparts a temperature range of processability that is necessary for accomplishing melt spinning of these polymers without substantial degradation or loss of molecular weight.

Useful thermoplastic poly(esteramide) elastomers include those described in U.S. Pat. No. 3,468,975, which is incorporated in its entirety as a part hereof for all purposes. For example, such elastomers can be prepared with polyester segments made by the reaction of one or more of ethylene glycol, 1,2-propanediol, 1,3-propanediol, 1,4-butanediol, 2,2-dimethyl-1,3-propanediol, 1,5-pentanediol, 1,6-hexanediol, 1,10-decandiol, 1,4-di(methylol)cyclohexane, diethylene glycol, or triethylene glycol with one or more of malonic acid, succinic acid, glutaric acid, adipic acid, 2-methyladipic acid, 3-methyladipic acid, 3,4-dimethyladipic acid, pimelic acid, suberic acid, azelaic acid, sebacic acid, or dodecandioic acid, or esters thereof.

Examples of polyamide segments in such poly(esteramide)s include those prepared by the reaction of hexamethylene diamine or dodecamethylene diamine with terephthalic acid, oxalic acid, adipic acid, or sebacic acid, and by the ring-opening polymerization of caprolactam.

Thermoplastic poly(etheramide) elastomers, such as those described in U.S. Pat. No. 4,230,838, which is incorporated in its entirety as a part hereof for all purposes, can also be used in the present invention. A dicarboxylic acid-terminated polyamide prepolymer is prepared from the reaction of a low molecular weight (for example, about 300 to about 15,000) polycaprolactam, polyoenantholactam, polydodecanolactam, polyundecanolactam, poly(11-aminoundecanoic acid), poly(12-aminododecanoic acid), poly(hexamethylene adipate), poly(hexamethylene azelate), poly(hexamethylene sebacate), poly(hexamethylene undecanoate), poly(hexamethylene dodecanoate), poly(nonamethylene adipate), or mixtures thereof and the like; with a diacid such as one or more of succinic acid, adipic acid, suberic acid, azelaic acid, sebacic acid, undecanedioic acid, terephthalic acid, or dodecanedioic acid, and the like. The prepolymer can then be reacted with an hydroxy-terminated polyether, for example poly(tetramethylene ether) glycol, poly(tetramethylene-co-2-methyltetramethylene ether) glycol, poly(propylene ether) glycol, poly(ethylene ether) glycol, or the like.

In a poly(esteramide) or a poly(etheramide), the weight-average molecular weight of the low-melting polyester or polyether segment is in the range of from about 200 g/mol to about 10000 g/mol, and preferably in the range of from about 400 g/mol to about 6000 g/mol. A further preferred range is from about 400 g/mol to about 3000 g/mol. The content of hard, polyamide, segments, by weight, in the poly(ester amide) or poly(ether amide) polymer may be from about 10% to about 70%, and is preferably from about 15% to about 35%. The content of soft segments, by weight, may be from about 30% to about 90%, and is preferably from about 85% to about 65%.

An olefinic thermoplastic elastomer may be employed in this invention as (i) the dispersed phase in a composition from which a fiber is spun, or (ii) the core or the sheath in a sheath/core fiber. Suitable olefins may be prepared using a conventional transition metal catalyst, such as a Ziegler-Natta catalyst, or using a metallocene, single site catalyst. Such elastomeric polyolefins include an ethylene polymer, which may be a homo- or copolymer. Suitable ethylene homopolymers include poly(4-methyl-1-pentene). An ethylene copolymer may be prepared from ethylene and an olefinic comonomer such as a diene or an α-olefin. The α-olefin may contain 3 to 30, and preferably 2-20 carbons, which may result in the presence of one or more pendent groups containing 1 to 28 carbons. Examples of suitable olefins for copolymerization include propylene, 1-butene, 1-pentene, 1-hexene, 1-octene, 1-heptene and 4-methyl-1-pentene, 4-methyl-1-hexene, and octadecene. An ethylene copolymer may contain from about 5 to about 30 weight percent of the olefinic comonomer with the balance being ethylene. An ethylene polymer used as a thermoplastic elastomer may be blended with a propylene polymer, if desired, for compatibilization purposes.

A propylene polymer, which may be a homo- or copolymer, may also be used herein as a thermoplastic elastomer. Exemplary propylene homopolymers having elastomeric characteristics are those prepared from a segments of isotactic or syndiotactic polypropylene, which are predominantly crystalline and hard, and segments of atactic polypropylene, which are predominantly amorphous and soft. Suitable elastomeric propylene copolymers include copolymers of propylene and an olefinic comonomer such as ethylene, a diene or an α-olefin as described above. A propylene copolymer may contain from about 5 to about 60 weight percent of the olefinic comonomer with the balance being propylene. Propylene polymers suitable for use in this invention are further described in EP 400,333, which is incorporated in its entirety as a part hereof for all purposes. A particularly suitable olefinic thermoplastic elastomer is an ethylene/propylene copolymer.

Suitable propylene copolymers have a crystallinity of from about 5 to about 50 percent, preferably from about 10 to about 40 percent, and more preferably from about 8 to about 30 percent. Crystallinity in a propylene polymer can be determined by differential scanning calorimetry (DSC) heating scans of a few milligrams of polymer. The DSC melting endotherm integrated from room temperature to above the end of melting at about 160° C. gives a total heat of fusion. This value is divided by the heat of fusion of 100% crystalline polypropylene of 207 J/g to give the percent crystallinity of the propylene polymer.

The thermoplastic elastomers used herein may contain various additives. Examples of such additives are pigments, fillers, extenders, plasticizers, color modifiers, antidegradants such as antioxidants, antiozonants, antistatic agents, compatibilizers (such as styrene/acrylonitrile copolymer, butadiene/acrylonitrile copolymer and ethyelene/vinyl acetate copolymer), thermal stabilizers, photostabilizers, and UV stabilizers, surfactants, waxes, flow promoters, particulates and materials added to enhance processability of the composition, and other blend components. The fiber of this invention may further contain or be covered with substances affecting the appearancethe processability or properties of the fiber in use. Examples hereof are matting agents, brightening agents, surfactants, dyes, pigments and light, UV and heat stabilizers.

An olefinic thermoplastic elastomer may be dispersed in a matrix of a segmented thermoplastic elastomer by using standard mixing methods known in the art. For example, they may be melt-mixed in a single screw or a twin screw extruder, formed into pellets, and then be re-melted for melt spinning. A mixture of olefinic and segmented thermoplastic elastomers can also be prepared by pellet blending and melt mixing in the melting step of spinning. A fiber, tape or film according to the invention may be prepared from a mixture of a segmented thermoplastic elastomer and an olefinic thermoplastic elastomer containing about 3 to about 80, and preferably about 5 to about 50, parts by weight of the olefinic thermoplastic elastomer against about 20 to about 97, and preferably about 50 to about 95, parts by weight of the segmented thermoplastic elastomer. The content of the olefinic thermoplastic elastomer in the above formulation is construed to be exclusive of any additives contained therein. The total of all weight parts may, but need not, add to 100.

To prepare a fiber, after the components of the spinning composition have been mixed, the mixture is fed to a spinning apparatus. The mixing system, in the form, for instance, of an extruder, may be integrated with the spinning apparatus. The mixture will typically be heated to a temperature higher than the melting or softening point of the segmented thermoplastic elastomer, where it becomes melt-processable. The mixture may then be supplied in that form to a spinneret with holes of the desired shape and size and in the desired quantity. The molten mixture may also be supplied to a spinning pump and from there to a spinneret. If so desired, the preparation of the mixture and the spinning may take place at separate times and places. The spinning apparatus used may be any known apparatus that is optionally capable of preparing and melting the mixture and forcing it at the desired speed through a spinneret having holes of the desired shape and size.

From the spinneret assembly, the fiber exits into air or in a space in which an inert gas or liquid is present. Depending on the mixture used, the gas, air or liquid may be kept at ambient temperature or at an elevated temperature, the latter preferably below the melting or softening point of the segmented thermoplastic elastomer. The fiber may be exposed also to a steam atmosphere immediately after exiting the spinneret assembly. In many cases, after it has followed a certain path through air, gas or steam, the spun fiber is passed through a liquid bath, particularly a water bath, for further and, if so desired, more rapid cooling. The fiber will thus cool and acquire a stable form and may be wound onto a bobbin. The fiber can be spun and wound onto a bobbin.

The cross-section of a fiber may be round, oval or multi-lobed, for instance tri-lobed. Examples of such shapes are to be found in Introductory Textile Science, Fifth Edition, by Marjory L. Joseph, published by Holt, Rinehart and Winston, Inc., page 40.

In a continuous spinning process, the fiber may be subjected to a draw-down operation after exiting the spinning zone while the fiber is still in wholly or partially molten condition. A drawing process yields a fiber of a desired denier. To lower the denier of a fiber, it may also be mechanically stretched immediately after spinning, or in a separate step, which will also serve to improve the tenacity at break. The drawn fibers according to the invention, or the individual filaments constituting a multifilament fiber have a denier in the range of from about 5 denier per foot (“dpf”) to about 2000 dpf, preferably a range of from about 10 dpf to about 300 dpf, and more preferably an range of from about 20 dpf to about 70 dpf.

Stretching of the fibers of this invention can be effected in a wide temperature range, for instance from 0° C. to nearly the melting temperature of the lowest melting polymer, but preferably not at a temperature higher than about 30° C. below the melting temperature of the lowest melting polymer. The melting point of a segmented polymer is determined mainly by the hard segment, and can be found using standard techniques such as DSC. The fiber may further be subjected to other after-treatments that are usual for fiber, such as heat treatment, shrinking, crimping and dyeing.

Another aspect of this invention involves the preparation of a sheath/core fiber in which the sheath is produced from a segmented thermoplastic elastomer and the core is produced from an olefinic thermoplastic elastomer, or vice versa. The sheath surrounds the core in a coaxial or concentric configuration. A sheath/core fiber is typically produced by coextrusion using two extruders sharing a common spin pack. The polymeric material used to make the core is channeled from a first extruder to the center of the spin plate holes, and the polymeric material used to make the sheath is channeled from a second extruder to the outside of the spin plate holes.

Using spinning compositions as described above, it is possible to produce fibers with a tenacity at break of no greater than about 1.0 gram per denier (gpd), and preferably no greater than about 1.5 gpd after stretching by 500% of the original length. It is also possible to produce fibers having a dpf as low as about 10, and preferably about 5.

The invention is not limited to low dpf fibers, however, as fibers having a dpf of up to about 25, about 50, about 100, or even about 250, dpf can be produced. Higher denier fibers of up to about 1000 dpf or more can be shaped as threads, tapes or films. Even at such high dpf, the good spinnability of the spinning compositions described above affords process advantages such as a high rate of production.

In addition to a fiber, this invention applies to a tape or film and, in general, any object measuring at most about 1000 μm, preferably at most about 500 μm, more preferably at most about 250 μm, and most preferably at most about 100, or even about 50, μm in at least one direction. As a result, the discussion herein concerning fibers applies equally to a tape or film, and a tape or film can be prepared by rolling a fiber to a flat shape or by extrusion through a die containing a slit orifice that imparts a flat shape.

The fibers made according to the invention may be applied as they are, but it is also possible for other fibers, particularly polyester, polyamide or cotton, to envelop them or to be wound or spun around them, or to be co-spun with them, or the fibers of the invention may be processed together with other fibers by techniques known in the art to form elastic yarns. In this manner, the fibers of the invention can be processed into a multi-fiber yarn having any desired fiber count and any desired dpf.

The fibers of the invention may be used to form fabrics by known means including by weaving, warp knitting, weft (including circular) knitting, or hosiery knitting. The fibers are useful in textiles, fabrics, and knitting, such as upholstery, and garments (including lingerie and hosiery) to form all, or a portion of the article, including narrows. Examples thereof are bathing wear, underwear, sportswear, leisurewear, stockings, tights, socks, or elastic bands in clothes. The fibers can also be useful for fabrics for outer cover material for personal care (e.g. human hygiene) articles and garment materials. Suitable personal care articles include infant care products such as disposable baby diapers, child care products such as training pants, and adult care products such as incontinence products, feminine care products and medical bandages. Suitable garment materials include items such as medical apparel, and work wear, and the like.

The present invention is further defined in the following examples, in which all parts and percentages are by weight and degrees are Celsius, unless otherwise stated. The advantageous effects of this invention are demonstrated by the examples below. The embodiments of the invention on which the examples are based are illustrative only, and do not limit the scope of the invention. The significance of the examples is better understood by comparing these embodiments of the invention with certain controlled formulations, which do not possess the distinguishing features of this invention.

In all examples and controls, the following abbreviations are used:

ELPP-A is an ethylene/propylene copolymer having 13% crystallinity in the propylene segment.

ELPP-B is an elastomeric propylene homopolymer having 32% crystallinity in the isotactic segment.

PEE-C is polyether ester elastomer with polybutylene terephthalate hard segment and poly(tetramethylene-co-2-methyltetramethyleneether) soft segment.

ELPP-D is a propylene homopolymer having 16% crystallinity in the isotactic segment.

Engage® elastomer is ethylene/octene copolymer with added compatibilized propylene homopolymer, obtained from DuPont-Dow Elastomers.

RT 2180 is a propylene homopolymer obtained from Huntsman Chemical Co.

RT 2280 is a propylene homopolymer obtained from Huntsman Chemical Co.

L/D ratio is the ratio of the length of the screw of an extruder to the diameter of the screw.

The mechanical properties of a fiber can be examined using an Instron® tensile testing machine at a testing speed of 51 cm/min and with the grips 5 cm apart, at the beginning of the testing.

### Experiment 1-Blend Films of ELPP with PEE

### EXAMPLE 1 AND CONTROLS A AND B

Blend films were made from 50% ELPP-A and 50% PEE-C. Melt blends were prepared using elastomeric polypropylene (13% and 30% crystallinity specimens) with polyether ester elastomers. Materials were melt blended at 230° C. using the CSI melt mixer to provide extruded strands. A separate step was used to press films at 230° C. between glass plates at a pressure of about 20 psi.

Properties are indicated in Table 1 below and show that the set property of 50/50 ELPP/PEE-C, measured as percent of the original size of the test sample, was improved over pure ELPP and approaches the set value of pure PEE-C. A small decrease in elongation of the blend was also observed.

Permanent elongation after stretching, or set was measured at room temperature by gripping a fiber of a given length in the jaws of a tensile testing machine and moving the jaws apart at a speed of 100 mm/min until the desired stretch was reached. Markings were provided on the fiber at a distance of 10 mm, (lₒ). The fiber was kept in its stretched state for 60 s, whereupon the tensile force acting on the fiber was removed. After allowing the fiber to relax at room temperature for 60 s, the tension set in percent was determined by dividing the difference in distance between the markings, l, on the fiber that had been allowed to relax after stretching and the original distance lₒ, between these markings by that original distance lₒ and multiplying the quotient by 100×([l−lₒ]/lₒ).

TABLE 1
Blend Films-Example 1-3

| | Control A | Example 1 | Control B |
|---|---|---|---|
| | ELPP-A/PEE-C | ELPP-A/PEE-C | ELPP-A/PEE-C |
| Property | 100/0 | 50/50 | 0/100 |
| Percent Set, | 110% | 70% | 75% |
| after 5 cycles | | | |
| to 300% | | | |
| elongation | | | |
| Percent | 850% | 580% | 750% |
| Elongation, | | | |
| at break | | | |

In the following examples and controls, unless otherwise provided, the experimental conditions used were as follows:

| Throughput of Spinning Pump | 0.3 | kg/hour |
|---|---|---|
| Residence time | 2 | min |
| Extruder Head Melt Temperature | 230° | C. |
| Spinning Block Spinneret Diameter | 0.229 | mm |
| L/D Ratio | 3 | |
| Windup Speed | 200 | m/min. |

### Experiment 2-Core/Sheath Fibers with ELPP Sheath

### EXAMPLES 2˜4 AND CONTROLS C AND D

Co-melt spinning with a sheath of polyolefin elastomer and segmented PEE core was accomplished using a two piston spinning unit. The melt temperatures were between 200° C. and 230° C. for the samples, and a 4× draw ratio and a 200 m/min wind-up speed was used to make ˜80 denier fibers. Polymer for the core was delivered through a central capillary, and the sheath polymer was delivered through a circular gap surrounding the central core. The core/sheath morphology was examined by microscopy studies of cross sections.

As the PEE-C component is increased to about 40%, elastic fiber properties such as % E (percent eleongation) after aging begin to approach those of a 100% PEE and are far superior to 100% ELPP-A. Values of % E in Table 2 show that for a 67% ELPP-A/33% PEE-C fiber that properties are more stable with time than 100% ELPP-A, and that the % E after 60 days reaches 310%, similar to that for 100% PEE-C after 60 days, while % E for 100% ELPP-A after 60 days is 200%.

These fibers have hydrophobic surfaces, and processing of fabrics and other use properties will be affected by the mostly hydrophobic ELPP fraction. Even at very high ELPP fractions of about 70%, fibers with elongation a factor of 1.5 better than 100%

ELPP are obtained. (4× Drawn Fibers)

TABLE 2
ELPP-A Sheath/PEE-C Core-Percent Elongation
Examples 2~4 and Controls C and D

| Time | Control C | Example 2 | Example 3 | Example 4 | Control D |
|---|---|---|---|---|---|
| Elapsed | ELPP- | ELPP- | ELPP- | ELPP- | ELPP- |
| after Fiber- | A/PEE-C | A/PEE-C | A/PEE-C | A/PEE-C | A/PEE-C |
| Spinning | 100/0 | 71/29 | 67/33 | 56/44 | 0/100 |
| % E-fresh | 330 | 315 | 400 | 440 | 580 |
| sample* | | | | | |
| % E after | 215 | 255 | 370 | 290 | 400 |
| 30 days | | | | | |
| % E after | 200 | 255 | 360 | 285 | 380 |
| 60 days | | | | | |

*(percent elongation property measured 5 min after spinning)

### Experiment 3-ELPP-A Core/PEE-C Sheath

Fibers were spun where sheath and core materials were reversed to give hydrophilic surfaces and higher melting components on the surface. Mechanical properties were consistent with those in Experiment 2 for the systems with the higher melting core configuration.

### Experiment 4-ELPP-B Sheath/PEE-C Core

### EXAMPLE 5 AND CONTROLS E AND F

An ELPP grade of lower elasticity and higher crystallinity was used in core/sheath fiber construction, giving lower percent elongation and elastic recovery, as disclosed in Table 3. The elasticity for core/sheath fibers containing ELPP-B (Example 5 and Control E) as measured by the percent elongation (% E) at break is low compared to 100% PEE-C (Control F), and becomes even lower after aging for the fibers containing ELPP-B (Table 3).

TABLE 3
Percent E versus Time for 4X drawn fibers
including blends with higher modulus ELPP

| | Control E | Example 5 | Control F |
|---|---|---|---|
| Time Elapsed after | ELPP-B/PEE-C | ELPP-B/PEE-C | ELPP-B/PEE-C |
| Fiber-Spinning | 100/0 | 59/41 | 0/100 |
| % E-fresh sample* | 150 | 210 | 580 |
| % E after 5 days | 85 | 105 | 460 |
| % E after 20 days | 85 | 100 | 400 |

*percent elongation property measured 5 min after spinning

### Experiment 5

### Fibers from ELPP/PEE Blends

### EXAMPLES 6 AND 7 AND CONTROLS G AND H

Blends were made by melt-mixing at ELPP in PEE matrix at 220° C. using a Custom Scientific Instruments (CSI) mixing extruder, CS194A. The fibers including blend fibers were melt spun using a single position-spinning piston driven unit. Approximately 15-70 dpf single filament fibers were spun, with a 50 m/min. feed role speed, and a 200 m/min windup speed giving a 4× mechanical drawing. A 0.015 inch capillary was typically used. Elastic properties in Table 4 for 30/70 ELPP-D/PEE-C show very high percent elongation compared to 100% ELPP-D. Blends with harder ELPP-B show reduced elongation and a high percent set. Also, the addition of ELPP component to the PEE lowered the fiber processing temperatures from 220° C. to 200° C. or less.

TABLE 4
4X Blend Fibers with PEE-C as One Component (Percent Elongation
at break, Percent Set after 5 cycles to 300% Elongation,
and Percent Recovery after 100% Elongation)

| | Control G | Example 6 | Example 7 | Control H |
|---|---|---|---|---|
| | ELPP-D/ | ELPP-D/ | ELPP-B/ | ELPP-D/ |
| | PEE-C | PEE-C | PEE-C | PEE-C |
| Property | 100/0 | 30/70 | 30/70 | 0/100 |
| Percent Set | Break | 45 | break | 50 |
| Percent | 200 | 420 | 230 | 560 |
| Elongation | | | | |
| Percent | 95 | 97 | 95 | 97 |
| Recovery | | | | |

### Experiment 6

### EXAMPLES 8˜18 AND CONTROLS I, J AND K

Freeze-ground pellets of each of the polyolefin elastomers used and PEE-C pellets were blended (salt and pepper) and subsequently compounded in a Baker-Perkins twin-screw extruder. The diameter of the screw flight was 4.921 cm (1.9375 in) and the screws operated at 100 rpm.

The feed zone of the extruder was maintained at 135° C. in all examples. The barrel temperatures were 180° C., 190° C., and 200° C. for two of the polyolefins, Huntsman RT-2180 and RT-2280. For Engage™ 8957 Elastomer, the barrel temperatures were 200° C., 210° C. and 220° C.

At the end of the extruder, a spinning block was attached which housed a melt filter-pack and a spinneret plate with 6 holes. The melt spinning temperature for each polymer system is reported in Table 6. The diameter of each hole was 0.483 mm (0.019 in) and the melt throughput was 180 g per hour per hole. The freshly spun filaments were cooled in ambient air without any forced air flow, or any special quenching apparatus.

The cooled filaments, after finish application, were wound up at 800 m/min on a standard winding equipment. The blend compositions in weight percent, and fiber properties of the pure PEE-C as well those of the blends are shown in Table 6 below.

TABLE 6

| | Blend | | Spinning | | Percent | Tensile | Tensile |
|---|---|---|---|---|---|---|---|
| Example or | Composition | | Temper- | Tenacity | Elongation-to | Modulus 1 | Modulus 2 |
| Control | Percent | | ature ° C. | gpd | Break | g/denier | g/denier |
| | PEE-C | RT-2180 | | | | | |
| I | 100% | 0% | 202 | 0.93 | 396 | 0.0086 | 0.0268 |
| 8 | 90% | 10% | 202 | 0.99 | 373 | 0.0074 | 0.0248 |
| 9 | 80% | 20% | 202 | 0.83 | 387 | 0.0057 | 0.0229 |
| | PEE-C | RT-2280 | | | | | |
| J | 100% | 0% | 202 | 0.93 | 396 | — | — |
| 10 | 95% | 5% | 202 | 0.98 | 387 | — | — |
| 11 | 90% | 10% | 202 | 0.92 | 395 | — | — |
| | PEE-C | Engage | | | | | |
| | | 8957 | | | | | |
| K | 100% | 0% | 233 | 0.79 | 387 | 0.0095 | 0.0258 |
| 12 | 95% | 5% | 233 | 0.75 | 412 | — | — |
| 13 | 90% | 10% | 233 | 0.88 | 409 | 0.0083 | 0.0237 |
| 14 | 85% | 15% | 233 | 0.76 | 442 | — | — |
| 15 | 80% | 20% | 233 | 0.50 | 375 | 0.0059 | 0.0219 |
| 16 | 80% | 20% | 233 | 0.40 | 324 | 0.0050 | 0.0217 |
| | (R) | | | | | | |
| 17 | 75% | 25% | 233 | 0.33 | 270 | — | — |
| 18 | 70% | 30% | 233 | 0.4 | 322 | 0.0042 | 0.189 |

### Experiment 7

### Washfastness Evaluation

### EXAMPLES 19˜23 AND CONTROLS L, M, N AND O

The washfastness test samples were supplied as 1 gram of film or fiber, and were pre-scoured before pressure dyeing at 130° C. for 30 min using 6% standard Palamil Blue 3RT dye. Elastomers including coated fibers were attached or stitched to a polyester fabric for the tests to evaluate washfastness. The evaluation procedure steps are as follows:

### Pre-Scour Treatment

The film, fiber, or the fabric samples were pre-scoured to remove knitting oils and finish. Samples were immersed in an aqueous liquor bath, which had been preheated to 43° C. The liquor contained Merpol LFH surfactant at a concentration of 0.5 g/L, and sodium triphosphate at a concentration of 0.5 g/L. The weight ratio of the film, fiber, or fabric samples to the liquor in the liquor bath was 1:20. The temperature of the bath was raised to 93° C. at a rate of 1.67° C./min. The scouring was subsequently run for 20 minutes at 93° C. The bath was cooled to 77° C. and the samples were rinsed with cold water until clear.

### Dyeing Treatment

Aqueous pressure dyeing was conducted at 130° C. in cylindrical pressure dyeing canisters. The film, fiber or fabric samples were immersed in an aqueous liquor bath, which had been preheated to 43° C. The liquor contained Merpol LFH surfactant at a concentration of 0.5 g/L. The weight ratio of the film, fiber or fabric samples to the liquor in the liquor bath was 1:20. A disperse dye was added at 6-8% based on the weight of fiber for dark shades. The pH was adjusted to 5.5 with acetic acid. The bath temperature was raised to 130° C. at 1.67° C./min, and the dyeing process was run for 30 min. The bath was cooled to 77° C., and the samples were rinsed with cold water until clear.

### Post-Scour Treatment

Reductive after-scour treatment is necessary to reduce dye at the fiber surface. The film, fiber or fabric samples were immersed in an aqueous liquor bath, which had been preheated to 27° C. The liquor contained Merpol LFH surfactant at a concentration of 0.5 g/L and soda ash at a concentration of 2.5 g/L. The weight ratio of the film, fiber or fabric samples to the liquor in the liquor bath was 1:20. After heating the bath 71° C. at 1.67° C./min, sodium hydrosulfite (5.0 g/L) was added. The samples were scoured for 20 minutes at 71° C. and rinsed several times until clear.

### Washfastness Evaluation

The degree of color uptake was evaluated in simulated laundry conditions. Test strips containing a series of representative fiber types, e.g., nylon, polyester, cotton and wool, were attached to the dyed samples. The dye absorption of the different test fabric types was evaluated by a qualitative visual inspection method, with a rating of 1 corresponding to the highest degree of dye transfer and absorption, and a rating of 5 corresponding to the lowest degree of dye transfer and the best washfastness.

Table 7 shows that for the acetate and nylon test strips, the washfastness improved from a rating of 1 for the uncoated poly(ether ester) control fibers (Control M) to 3 for Examples 19 and 20, which are poly(ether ester) coated with polypropylene (71% and 56% by weight polypropylene sheath, respectively), where 1 is rated the worst performing and 5 is the best performing in terms of washfastness. This is a substantial improvement in washfastness rating and is essentially equivalent to 100% polypropylene fiber (Control L).

The other test strips did not show clear trends for these systems because they were not substantially stained. In Example 21, the core/sheath fiber had an ELPP core, and because of the poly(ether ester) on the outside, the washfastness was decreased as compared to the use of ELPP as the sheath.

TABLE 7
Washfastness of elastomers after Palamil Blue
3RT disperse dyeing and after-scour.

| | Fabrics | Ace- | | | | | |
|---|---|---|---|---|---|---|---|
| | Samples | tate | Cotton | Nylon | Dacron | Orlon | Wool |
| L | ELPP Control | 3 | 4 | 3 | 4 | 4-5 | 3-4 |
| M | PEE-C Control* | 1 | 3-4 | 1 | 3-4 | 4-5 | 3 |
| 19 | ELPP/PEE-C, | 2-3 | 4 | 3 | 4 | 4-5 | 3-4 |
| | Sheath/Core | | | | | | |
| | 71/29 | | | | | | |
| 20 | ELPP/PEE-C, | 3-4 | 4 | 3 | 4 | 4-5 | 4 |
| | Sheath/Core | | | | | | |
| | 56/44 | | | | | | |
| 21 | PEE-C/ELPP, | 2 | 4 | 2 | 4 | 4-5 | 3 |
| | Sheath/Core | | | | | | |
| | 50/50 | | | | | | |
| N | 100% PET Fabric | 3-4 | 4 | 3 | 4 | 4-5 | 4 |

All elastomers were mixed with 75% PET Fabric except for the “100% PET fabric” control. A value of 1 is the worst staining, and a value of 5 is minimal staining.

The following samples were re-tested to verify reproducibility of washfastness evaluation.

TABLE 8

| | Fabrics | Ace- | | | | | |
|---|---|---|---|---|---|---|---|
| | Samples | tate | Cotton | Nylon | Dacron | Orlon | Wool |
| O | PEE-C Control* | 1 | 4 | 1 | 3 | 5 | 2-3 |
| 22 | ELPP/PEE-C, | 3 | 4 | 3 | 4 | 5 | 4 |
| | Sheath/Core | | | | | | |
| | 56/44 | | | | | | |
| 23 | ELPP/PEE-C, | 3 | 4 | 3 | 3-4 | 5 | 3-4 |
| | Sheath/Core | | | | | | |
| | 50/50 | | | | | | |

What is claimed is:

1. A fiber comprising (a) a segmented thermoplastic, elastomeric poly(ether ester) polymer, and (b) an uncrosslinked thermoplastic, elastomeric propylene homopolymer characterized by a crystallinity of from about 10 to about 40% and an end of melting at about 160° C. as determined by differential scanning calorimetry, wherein the thermoplastic, elastomeric propylene homopolymer is dispersed in a matrix of the segmented thermoplastic, elastomeric poly(ether/ester) polymer.

2. A fiber according to claim 1 wherein the propylene homopolymer comprises crystalline segments of isotactic polypropylene and amorphous segments of atactic polypropylene.

3. A fiber according to claim 1 which comprises the propylene polymer in an amount of from about 3% to about 80% by weight.

4. A yarn prepared from a fiber according to claim 1.

5. A fabric prepared from a fiber according to claim 1.

6. A garment prepared from a fiber according to claim 1.

7. A stretchable band, in an article for human hygiene, prepared from a fiber according to claim 1.

8. A fiber according to claim 1 further comprising a surfactant or compatibilizer.
